(19) United States
(12) Patent Application Publication
(10) Pub. No.: US 2020/0260537 A1
(43) Pub. Date: Aug. 13, 2020

(54) THERMALLY INSULATED COVERS FOR CONDENSATION INHIBITION IN AN OVEN

(71) Applicant: ILLINOIS TOOL WORKS INC., Glenview (IL)

(72) Inventors: Marco Carcano, Senago (IT); Michele Sclocchi, San Donato Milanese (IT); Andrea Baccara, Chicago, IL (US); Michele Gentile, Jesi (IT)

(21) Appl. No.: 16/778,047

(22) Filed: Jan. 31, 2020

Related U.S. Application Data
(60) Provisional application No. 62/804,396, filed on Feb. 12, 2019.

(51) Int. Cl. H05B 6/64; H05B 6/68; F24C 15/00; F24C 15/34; F24C 15/36; F24C 7/08

(52) U.S. Cl. CPC H05B 6/642; H05B 6/686; F24C 7/087; F24C 15/34; F24C 15/36; F24C 15/006

(57) ABSTRACT

An oven may include an oven body having at least sides and a housing cover, a cooking chamber disposed within the oven body and being configured to receive a food product, an RF heating system configured to provide RF energy into the cooking chamber using solid state electronic components to heat the food product, and an internal air cooling system configured to move air through the oven body to cool the solid state electronic components. The solid state electronic components include power amplifier electronics and control electronics configured to control operation of the power amplifier electronics. The power amplifier electronics are at least partially covered by an internal electronics cover. A first insulating member is applied to a bottom surface of at least one of the housing cover or the internal electronics cover to inhibit condensation above the solid state electronic components.

### CROSS-REFERENCE TO RELATED APPLICATIONS

The present application claims priority to U.S. Provisional Application No. 62/804,396, filed on Feb. 12, 2019, the contents of which are hereby, incorporated herein by reference in its entirety.

### TECHNICAL FIELD

Example embodiments generally relate to ovens and, more particularly, relate to an oven that uses radio frequency (RF) heating under the control of solid state components and thermally insulated covers that prevent internal condensation or steam damage to such components.

### BACKGROUND

Combination ovens that are capable of cooking using more than one heating source (e.g., convection, steam, microwave, etc.) have been in use for decades. Each cooking source comes with its own distinct set of characteristics. Thus, a combination oven can typically leverage the advantages of each different cooking source to attempt to provide a cooking process that is improved in terms of time and/or quality. More recently, ovens with improved capabilities relative to cooking food with a combination of controllable RF energy and convection energy have been introduced. Unlike the relatively indiscriminate bombarding of food product, which generally occurs in microwave cooking, the use of controllable RF energy can enable a much more fine-tuned control of the cooking process. This fine-tuned control of the cooking process can lead to superior results in vastly shortened time periods.

The use of RF within an oven with fine-tuned control has been enabled by the use of solid state components that control power amplifiers supplying waveguides that feed the RF into the cooking chamber of the oven. While the cooking results that can be achieved from this type of oven are superior, there are some challenges that arise due to using solid state components within the oven context. In particular, the solid state components and power amplifiers used may generate a relatively high heat load. In order to avoid component failure, this heat load must be efficiently managed.

To manage the heat load generated by the solid state components and power amplifiers, various tools such as fans, heat sinks and/or other structures may be employed. However, since the ovens may be used in various different environments that may be cooler than the inside of the oven housing, a temperature differential may exist between the inside and outside of the oven housing. Moreover, since the heat removal structures may partition off certain portions within the internal structures of the oven in order to manage air flow or otherwise facilitate heat removal from certain components, the partitions created may also generate temperature differentials between adjacent portions of the inside of the oven housing. When the warm air used inside the oven housing for component cooling has moisture therein, these temperature differentials across various metallic surfaces or structures within the oven housing can lead to condensation forming on metallic surfaces that are cooler than the moist surrounding air. In particular, the warm, moist air contacts a cooler metallic surface and begins to cool. The cooling of the air causes the cooling air to have less capacity to retain moisture, so the moisture or water is released in the form of condensation on the cooler metallic surface.

The formation of condensation within the oven housing can be particularly dangerous if the condensation drips or otherwise comes into contact with electronic components in the oven. Accordingly, actions should be taken to avoid the formation of condensation within the oven housing. However, given the possibility of operating ovens in some challenging environments, design improvements may be put in place to strategically address certain risk areas to ensure that condensation can be avoided at least in those risk areas.

### BRIEF SUMMARY OF SOME EXAMPLES

In an example embodiment, an oven is provided. The oven may include an oven body having at least sides and a housing cover, a cooking chamber disposed within the oven body and being configured to receive a food product, an RF heating system configured to provide RF energy into the cooking chamber using solid state electronic components to heat the food product, and an internal air cooling system configured to move air through the oven body to cool the solid state electronic components. The solid state electronic components may include power amplifier electronics and control electronics configured to control operation of the power amplifier electronics. The power amplifier electronics may be at least partially covered by an internal electronics cover. A first insulating member may be applied to a bottom surface of at least one of the housing cover or the internal electronics cover to inhibit condensation above the solid state electronic components.

In another example embodiment, a method of inhibiting condensation formation in an oven body of an oven having solid state electronic components used to control RF heating in a cooking chamber of the oven is provided. An internal air cooling system may be configured to move air through the oven body to cool the solid state electronic components. The method may include disposing an internal electronics cover over the solid state components, applying a first insulating member to a bottom surface of the internal electronics cover to inhibit condensation buildup on the bottom surface of the internal electronics cover, and applying a second insulating member to a bottom surface of the housing cover to inhibit condensation buildup on the bottom surface of the housing cover.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of an oven capable of employing at least two energy sources according to an example embodiment;

FIG. 2 illustrates a functional block diagram of the oven of FIG. 1 according to an example embodiment;

FIG. 3A shows a cross sectional view of the oven from a plane passing from the front to the back of the oven according to an example embodiment;

FIG. 3B illustrates an exploded perspective view of control electronics and other components associated with a power amplifier casing in accordance with an example embodiment;

FIG. 3C illustrates an alternative exploded perspective view of control electronics and other components associated with the power amplifier casing in accordance with an example embodiment;

FIG. 3D illustrates another exploded perspective view of control electronics and other components associated with the power amplifier casing in accordance with an example embodiment;

FIG. 3E illustrates still another exploded perspective view of control electronics and other components associated with the power amplifier casing in accordance with an example embodiment;

FIG. 4 is a top view of an attic region of the oven in accordance with an example embodiment;

FIG. 5A is an exploded, perspective view of the housing cover and a housing cover insulator in accordance with an example embodiment;

FIG. 5B illustrates a side view of the housing cover from the front perspective with the housing cover and housing cover insulator fully assembled in accordance with an example embodiment;

FIG. 5C illustrates a cross section view taken through a centerline of the oven extending from front to back of the oven in accordance with an example embodiment;

FIG. 6A illustrates an exploded, perspective view of the power amplifier casing and corresponding insulator in accordance with an example embodiment;

FIG. 6B illustrates a cross sectional view taken through a transverse centerline of the power amplifier casing in accordance with an example embodiment; and

FIG. 7 illustrates a block diagram of a method of inhibiting condensation formation in an oven body in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may improve the cooking performance of an oven and/or may improve the operator experience of individuals employing an example embodiment. In this regard, the oven may cook food relatively quickly and uniformly, based on the application of RF energy under the instruction of solid state power amplification and control electronics that are configured to achieve optimal cooking results in terms of efficiency and/or uniformity. The efficiency improvement may be achieved by the effective delivery of power to the load, resulting in faster cooking, and the uniformity may be noticed by more even heating over the entire portion of the food that is treated by the oven. However, the use of RF energy as described above may also cause a need for thermal management within the oven to avoid damage to the solid state power amplification and control electronics due to condensation or steam formation.

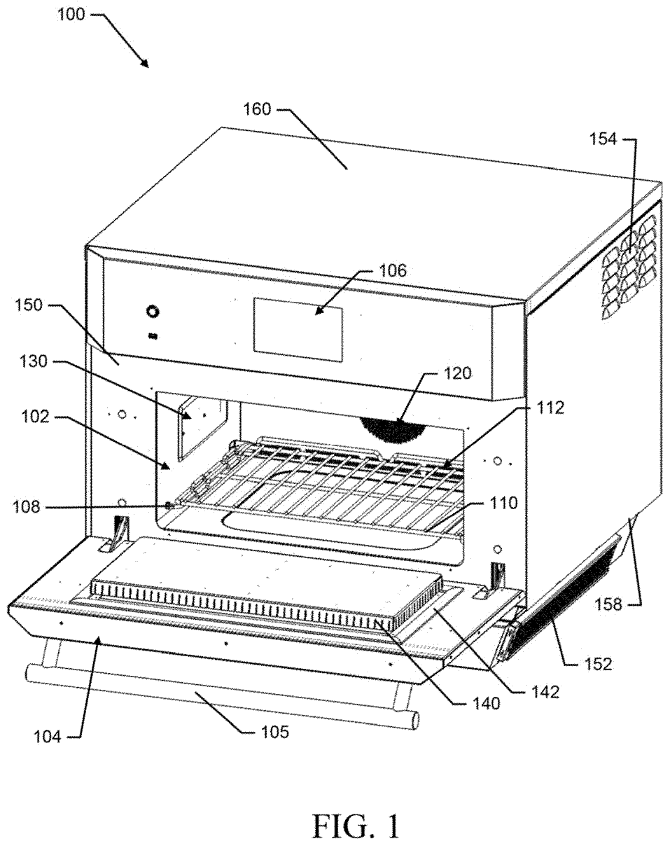

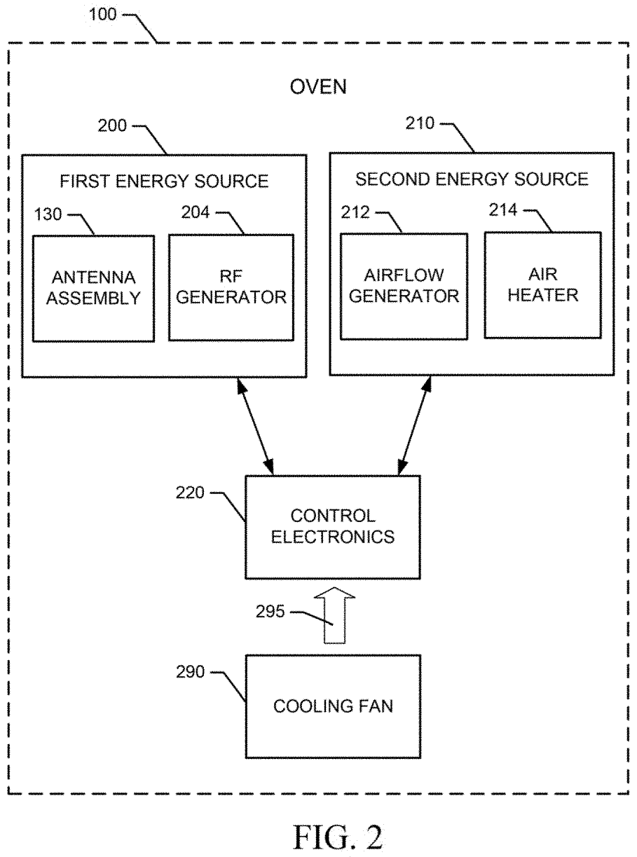

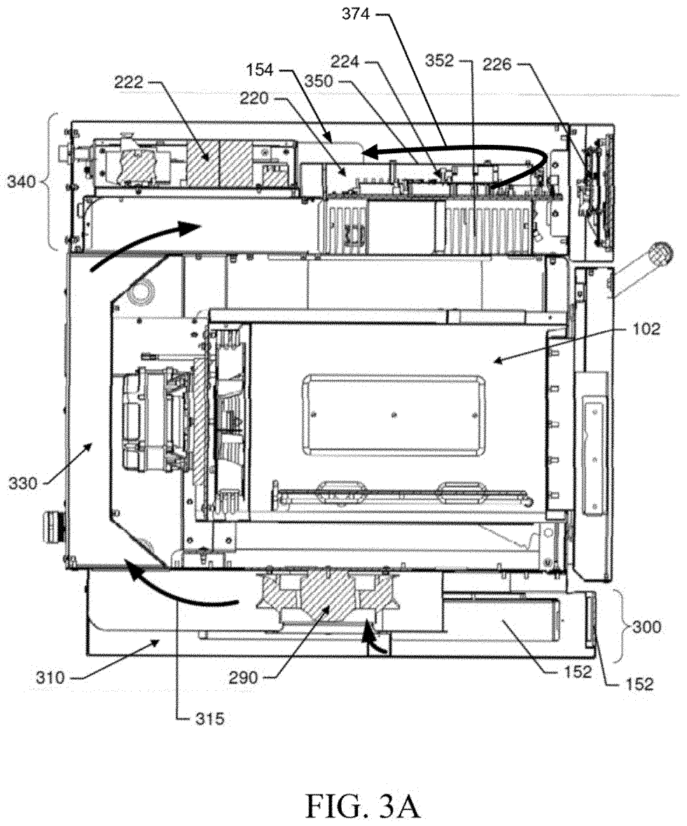

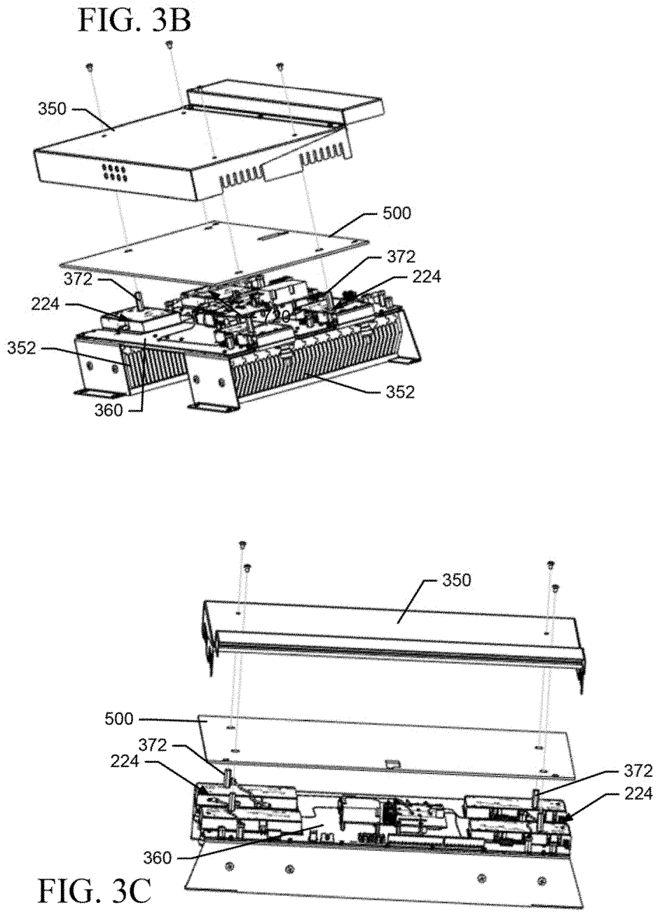

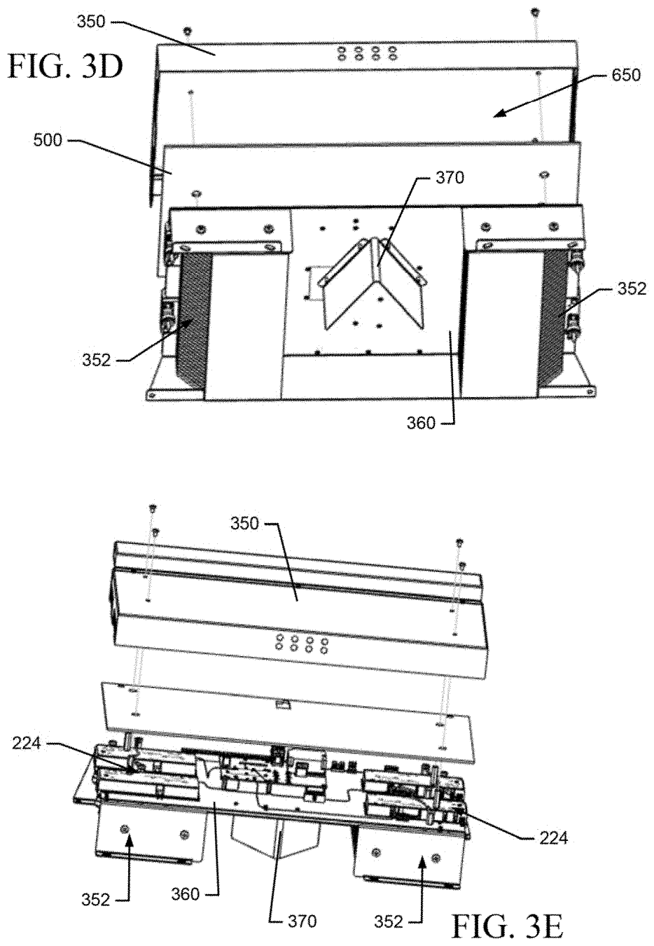

In this regard, example embodiments employ power amplifier electronics components that can be controlled so that cooking parameters can be efficiently and uniformly managed. Electronics within the system will generate heat that needs to be removed. Example embodiments provide structures for removal of such heat, but further provide for strategically insulating specific components to avoid condensation in particularly sensitive areas by providing an insulating member on metal surfaces above such components. Some example structures describing these solutions, and specific examples of insulating members that may be useful in this context, will be discussed below in reference to FIGS. 3-6. However, first a further description of the environmental context in which this problem arose will be discussed in reference to FIGS. 1-2.

FIG. 1 illustrates a perspective view of an oven 100 according to an example embodiment. As shown in FIG. 1, the oven 100 may include a cooking chamber 102 into which a food product may be placed for the application of heat by any of at least two energy sources that may be employed by the oven 100. The cooking chamber 102 may include a door 104 and an interface panel 106, which may sit proximate to the door 104 when the door 104 is closed. The door 104 may be operable via handle 105, which may extend across the front of the oven 100 parallel to the ground. In some cases, the interface panel 106 may be located substantially above the door 104 (as shown in FIG. 1) or alongside the door 104 in alternative embodiments. In an example embodiment, the interface panel 106 may include a touch screen display capable of providing visual indications to an operator and further capable of receiving touch inputs from the operator. The interface panel 106 may be the mechanism by which instructions are provided to the operator, and the mechanism by which feedback is provided to the operator regarding cooking process status, options and/or the like.

In some embodiments, the oven 100 may include multiple racks or may include rack (or pan) supports 108 or guide slots in order to facilitate the insertion of one or more racks 110 or pans holding food product that is to be cooked. In an example embodiment, air delivery orifices 112 may be positioned proximate to the rack supports 108 (e.g., just below a level of the rack supports in one embodiment) to enable heated air to be forced into the cooking chamber 102 via a heated-air circulation fan (not shown in FIG. 1). The heated-air circulation fan may draw air in from the cooking chamber 102 via a chamber outlet port 120 disposed at a back or rear wall (i.e., a wall opposite the door 104) of the cooking chamber 102. Air may be circulated from the chamber outlet port 120 back into the cooking chamber 102 via the air delivery orifices 112. After removal from the cooking chamber 102 via the chamber outlet port 120, air may be cleaned, heated, and pushed through the system by other components prior to return of the clean, hot and speed controlled air back into the cooking chamber 102. This air circulation system, which includes the chamber outlet port 120, the air delivery orifices 112, the heated-air circulation fan, cleaning components, and all ducting therebetween, may form a first air circulation system within the oven 100.

In an example embodiment, food product placed on a pan or one of the racks 110 (or simply on a base of the cooking chamber 102 in embodiments where racks 110 are not employed) may be heated at least partially using radio frequency (RF) energy. Meanwhile, the airflow that may be provided may be heated to enable further heating or even browning to be accomplished. Of note, a metallic pan may be placed on one of the rack supports 108 or racks 110 of some example embodiments. However, the oven 100 may be configured to employ frequencies and/or mitigation strategies for detecting and/or preventing any arcing that might otherwise be generated by using RF energy with metallic components.

In an example embodiment, the RF energy may be delivered to the cooking chamber 102 via an antenna assembly 130 disposed proximate to the cooking chamber 102. In some embodiments, multiple components may be provided in the antenna assembly 130, and the components may be placed on opposing sides of the cooking chamber 102. The antenna assembly 130 may include one or more instances of a power amplifier, a launcher, waveguide and/or the like that are configured to couple RF energy into the cooking chamber 102.

The cooking chamber 102 may be configured to provide RF shielding on five sides thereof (e.g., the top, bottom, back, and right and left sides), but the door 104 may include a choke 140 to provide RF shielding for the front side. The choke 140 may therefore be configured to fit closely with the opening defined at the front side of the cooking chamber 102 to prevent leakage of RF energy out of the cooking chamber 102 when the door 104 is shut and RF energy is being applied into the cooking chamber 102 via the antenna assembly 130.

In an example embodiment, a gasket 142 may be provided to extend around the periphery of the choke 140. In this regard, the gasket 142 may be formed from a material such as wire mesh, rubber, silicon, or other such materials that may be somewhat compressible between the door 104 and a periphery of the opening into the cooking chamber 102. The gasket 142 may, in some cases, provide a substantially air tight seal. However, in other cases (e.g., where the wire mesh is employed), the gasket 142 may allow air to pass therethrough. Particularly in cases where the gasket 142 is substantially air tight, it may be desirable to provide an air cleaning system in connection with the first air circulation system described above.

The antenna assembly 130 may be configured to generate controllable RF emissions into the cooking chamber 102 using solid state components. Thus, the oven 100 may not employ any magnetrons, but instead use only solid state components for the generation and control of the RF energy applied into the cooking chamber 102. The use of solid state components may provide distinct advantages in terms of allowing the characteristics (e.g., power/energy level, phase and frequency) of the RF energy to be controlled to a greater degree than is possible using magnetrons. However, since relatively high powers are necessary to cook food, the solid state components themselves will also generate relatively high amounts of heat, which must be removed efficiently in order to keep the solid state components cool and avoid damage thereto. To cool the solid state components, the oven 100 may include a second air circulation system.

The second air circulation system may operate within an oven body 150 (or housing) of the oven 100 to circulate cooling air for preventing overheating of the solid state components that power and control the application of RF energy to the cooking chamber 102. The second air circulation system may include an inlet array 152 that is formed at a bottom (or basement) portion of the oven body 150. In particular, the basement region of the oven body 150 may be a substantially hollow cavity within the oven body 150 that is disposed below the cooking chamber 102. The inlet array 152 may include multiple inlet ports that are disposed on each opposing side of the oven body 150 (e.g., right and left sides when viewing the oven 100 from the front) proximate to the basement, and also on the front of the oven body 150 proximate to the basement. Portions of the inlet array 152 that are disposed on the sides of the oven body 150 may be formed at an angle relative to the majority portion of the oven body 150 on each respective side. In this regard, the portions of the inlet array 152 that are disposed on the sides of the oven body 150 may be tapered toward each other at an angle of about twenty degrees (e.g., between ten degrees and thirty degrees). This tapering may ensure that even when the oven 100 is inserted into a space that is sized precisely wide enough to accommodate the oven body 150 (e.g., due to walls or other equipment being adjacent to the sides of the oven body 150), a space is formed proximate to the basement to permit entry of air into the inlet array 152. At the front portion of the oven body 150 proximate to the basement, the corresponding portion of the inlet array 152 may lie in the same plane as (or at least in a parallel plane to) the front of the oven 100 when the door 104 is closed. No such tapering is required to provide a passage for air entry into the inlet array 152 in the front portion of the oven body 150 since this region must remain clear to permit opening of the door 104.

From the basement, ducting may provide a path for air that enters the basement through the inlet array 152 to move upward (under influence from a cool-air circulating fan) through the oven body 150 to an attic portion inside which control electronics (e.g., the solid state components) are located. The attic portion may include various structures for ensuring that the air passing from the basement to the attic and ultimately out of the oven body 150 via outlet louvers 154 is passed proximate to the control electronics to remove heat from the control electronics. Hot air (i.e., air that has removed heat from the control electronics) is then expelled from the outlet louvers 154. In some embodiments, outlet louvers 154 may be provided at right and left sides of the oven body 150 and at the rear of the oven body 150 proximate to the attic. In some cases, the attic may be bounded at its sides by portions of the sides of the oven body 150 (e.g., sidewalls) that are proximate to the outlet louvers 154. The attic may be bounded at its top by housing cover 160. The housing cover 160 may be a substantially rectangular shaped metallic structure (e.g., sheet metal) that extends over the top of the oven 100 and further facilitates directing air from the attic out of the outlet louvers 154.

Placement of the inlet array 152 at the basement and the outlet louvers 154 at the attic ensures that the normal tendency of hotter air to rise will prevent recirculation of expelled air (from the outlet louvers 154) back through the system by being drawn into the inlet array 152. Furthermore, the inlet array 152 is at least partially shielded from any direct communication path from the outlet louvers 154 by virtue of the fact that, at the oven sides (which include both portions of the inlet array 152 and outlet louvers 154), the shape of the basement is such that the tapering of the inlet array 152 is provided on walls that are also slightly inset to create an overhang 158 that blocks any air path between inlet and outlet. As such, air drawn into the inlet array 152 can reliably be expected to be air at ambient room temperature, and not recycled, expelled cooling air.

As discussed above, the warm air that is heated during the cooling process for cooling oven electronics may move through the inside of the oven body 150 contacting various surfaces of the oven body 150 and other internal structures of the oven 100. Particularly when the oven 100 is in an environment having a cooler ambient temperature than the temperature in the attic, the housing cover 160 may be cooled by the ambient temperature. As the warm air inside the attic contacts the cooler housing cover 160, the air may be cooled and lose some of its capacity to retain moisture. The moisture may therefore tend to condense on the surface (i.e., the bottom or inner surface) of the housing cover 160 and potentially become problematic. To avoid this situation, example embodiments may employ a housing cover insulator as described in greater detail below.

FIG. 2 illustrates a functional block diagram of the oven 100 according to an example embodiment. As shown in FIG. 2, the oven 100 may include at least a first energy source 200 and a second energy source 210. The first and second energy sources 200 and 210 may each correspond to respective different cooking methods. In some embodiments, the first and second energy sources 200 and 210 may be an RF heating source and a convective heating source, respectively. However, it should be appreciated that additional or alternative energy sources may also be provided in some embodiments. Moreover, some example embodiments could be practiced in the context of an oven that includes only a single energy source (e.g., the second energy source 210). As such, example embodiments could be practiced on otherwise conventional ovens that apply heat using, for example, gas or electric power for heating.

As mentioned above, the first energy source 200 may be an RF energy source (or RF heating source) configured to generate relatively broad spectrum RF energy or a specific narrow band, phase controlled energy source to cook food product placed in the cooking chamber 102 of the oven 100. Thus, for example, the first energy source 200 may include the antenna assembly 130 and an RF generator 204. The RF generator 204 of one example embodiment may be configured to generate RF energy at selected levels and with selected frequencies and phases. In some cases, the frequencies may be selected over a range of about 6 MHz to 246 GHz. However, other RF energy bands may be employed in some cases. In some examples, frequencies may be selected from unlicensed frequency (e.g., the ISM) bands for application by the RF generator 204.

In some cases, the antenna assembly 130 may be configured to transmit the RF energy into the cooking chamber 102 and receive feedback to indicate absorption levels of respective different frequencies in the food product. The absorption levels may then be used to control the generation of RF energy to provide balanced cooking of the food product. Feedback indicative of absorption levels is not necessarily employed in all embodiments however. For example, some embodiments may employ algorithms for selecting frequency and phase based on pre-determined strategies identified for particular combinations of selected cook times, power levels, food types, recipes and/or the like. In some embodiments, the antenna assembly 130 may include multiple antennas, waveguides, launchers, and RF transparent coverings that provide an interface between the antenna assembly 130 and the cooking chamber 102. Thus, for example, four waveguides may be provided and, in some cases, each waveguide may receive RF energy generated by its own respective power module or power amplifier of the RF generator 204 operating under the control of control electronics 220. In an alternative embodiment, a single multiplexed generator may be employed to deliver different energy into each waveguide or to pairs of waveguides to provide energy into the cooking chamber 102.

In an example embodiment, the second energy source 210 may be an energy source capable of inducing browning and/or convective heating of the food product. Thus, for example, the second energy source 210 may a convection heating system including an airflow generator 212 and an air heater 214. The airflow generator 212 may be embodied as or include the heated-air circulation fan or another device capable of driving airflow through the cooking chamber 102 (e.g., via the air delivery orifices 112). The air heater 214 may be an electrical heating element or other type of heater that heats air to be driven toward the food product by the airflow generator 212. Both the temperature of the air and the speed of airflow will impact cooking times that are achieved using the second energy source 210, and more particularly using the combination of the first and second energy sources 200 and 210.

In an example embodiment, the first and second energy sources 200 and 210 may be controlled, either directly or indirectly, by the control electronics 220. The control electronics 220 may be configured to receive inputs descriptive of the selected recipe, food product and/or cooking conditions in order to provide instructions or controls to the first and second energy sources 200 and 210 to control the cooking process. In some embodiments, the control electronics 220 may be configured to receive static and/or dynamic inputs regarding the food product and/or cooking conditions. Dynamic inputs may include feedback data regarding phase and frequency of the RF energy applied to the cooking chamber 102. In some cases, dynamic inputs may include adjustments made by the operator during the cooking process. The static inputs may include parameters that are input by the operator as initial conditions. For example, the static inputs may include a description of the food type, initial state or temperature, final desired state or temperature, a number and/or size of portions to be cooked, a location of the item to be cooked (e.g., when multiple trays or levels are employed), a selection of a recipe (e.g., defining a series of cooking steps) and/or the like.

In some embodiments, the control electronics 220 may be configured to also provide instructions or controls to the airflow generator 212 and/or the air heater 214 to control airflow through the cooking chamber 102. However, rather than simply relying upon the control of the airflow generator 212 to impact characteristics of airflow in the cooking chamber 102, some example embodiments may further employ the first energy source 200 to also apply energy for cooking the food product so that a balance or management of the amount of energy applied by each of the sources is managed by the control electronics 220.

In an example embodiment, the control electronics 220 may be configured to access algorithms and/or data tables that define RF cooking parameters used to drive the RF generator 204 to generate RF energy at corresponding levels, phases and/or frequencies for corresponding times determined by the algorithms or data tables based on initial condition information descriptive of the food product and/or based on recipes defining sequences of cooking steps. As such, the control electronics 220 may be configured to employ RF cooking as a primary energy source for cooking the food product, while the convective heat application is a secondary energy source for browning and faster cooking. However, other energy sources (e.g., tertiary or other energy sources) may also be employed in the cooking process.

In some cases, cooking signatures, programs or recipes may be provided to define the cooking parameters to be employed for each of multiple potential cooking stages or steps that may be defined for the food product and the control electronics 220 may be configured to access and/or execute the cooking signatures, programs or recipes (all of which may generally be referred to herein as recipes). In some embodiments, the control electronics 220 may be configured to determine which recipe to execute based on inputs provided by the user except to the extent that dynamic inputs (i.e., changes to cooking parameters while a program is already being executed) are provided. In an example embodiment, an input to the control electronics 220 may also include browning instructions. In this regard, for example, the browning instructions may include instructions regarding the air speed, air temperature and/or time of application of a set air speed and temperature combination (e.g., start and stop times for certain speed and heating combinations). The browning instructions may be provided via a user interface accessible to the operator, or may be part of the cooking signatures, programs or recipes.

As discussed above, the first air circulation system may be configured to drive heated air through the cooking chamber 102 to maintain a steady cooking temperature within the cooking chamber 102. Meanwhile, the second air circulation system may cool the control electronics 220. The first and second air circulation systems may be isolated from each other. However, each respective system generally uses differential pressures (e.g., created by fans) within various compartments formed in the respective systems to drive the corresponding air flows needed for each system. While the airflow of the first air circulation system is aimed at heating food in the cooking chamber 102, the airflow of the second air circulation system is aimed at cooling the control electronics 220. As such, cooling fan 290 provides cooling air 295 to the control electronics 220, as shown in FIG. 2.

The structures that form the air cooling pathways via which the cooling fan 290 cools the control electronics 220 may be designed to provide efficient delivery of the cooling air 295 to the control electronics 220, but also minimize fouling issues or dust/debris buildup in sensitive areas of the oven 100, or areas that are difficult to access and/or clean. Meanwhile, the structures that form the air cooling pathways may also be designed to maximize the ability to access and clean the areas that are more susceptible to dust/debris buildup. Furthermore, the structures that form the air cooling pathways via which the cooling fan 290 cools the control electronics 220 may be designed to strategically employ various natural phenomena to further facilitate efficient and effective operation of the second air circulation system. In this regard, for example, the tendency of hot air to rise, and the management of high pressure and low pressure zones necessarily created by the operation of fans within the system may each be employed strategically by the design and placement of various structures to keep certain areas that are hard to access relatively clean and other areas that are otherwise relatively easy to access more likely to be places where cleaning is needed.

The typical airflow path, and various structures of the second air circulation system, can be seen in FIG. 3A. In this regard, FIG. 3A shows a cross sectional view of the oven 100 from a plane passing from the front to the back of the oven 100. Meanwhile, FIGS. 3B, 3C, 3D and 3E illustrate various exploded perspective views of the control electronics 220 and other components associated therewith in relation to cooling the control electronics 220. Referring now to FIGS. 3A to 3E, the basement (or basement region 300) of the oven 100 is defined below the cooking chamber 102, and includes an inlet cavity 310. During operation, air is drawn into the inlet cavity 310 through the inlet array 152 and is further drawn into the cooling fan 290 before being forced radially outward (as shown by arrow 315) away from the cooling fan 290 into a riser duct 330 (e.g., a chimney) that extends from the basement region 300 to the attic (or attic region 340) to turn air upward (as shown by arrow 315). Air is forced upward through the riser duct 330 into the attic region 340, which is where components of the control electronics 220 are disposed. The air then cools the components of the control electronics 220 before exiting the body 150 of the oven 100 via the outlet louvers 154. The components of the control electronics 220 may include power supply electronics 222, power amplifier electronics 224 and display electronics 226.

Upon arrival of air into the attic region 340, the air is initially guided from the riser duct 330 to a power amplifier casing 350. The power amplifier casing 350 may house the power amplifier electronics 224. In particular, the power amplifier electronics 224 may sit on an electronic board 360 to which all such components are mounted. The power amplifier electronics 224 may therefore include one or more power amplifiers that are mounted to the electronic board 360 for powering the antenna assembly 130. Thus, the power amplifier electronics 224 may generate a relatively large heat load. To facilitate dissipation of this relatively large heat load, the power amplifier electronics 224 may be mounted to one or more heat sinks 352. In other words, the electronic board 360 may be mounted to the one or more heat sinks 352 such that, for example, the heat sinks 352 are disposed beneath the electronic board 360. The heat sinks 352 may include large metallic fins that extend away from the electronic board 360 to which the power amplifier electronics 224 are mounted. Thus, the fins may extend downwardly (toward the cooking chamber 102). The fins may also extend in a transverse direction away from a centerline (from front to back) of the oven 100 to guide air provided into the power amplifier casing 350 and past the fins of the heat sinks 352.

In some cases, the fins of the heat sinks 352 may be split into two sections divided from each other by the centerline. Moreover, a guide vane 370 may be disposed along the centerline to direct incoming air toward the fins of the heat sinks 352. Air may therefore pass both above and below the electronic board 360 to pass proximate to the heat sinks 352 and the power amplifier electronics 224. Of note, spacer rods 372 may be disposed to extend upwardly away from the electronic board 360 to support the power amplifier casing 350 and define a gap between the power amplifier casing 350 and either or both of the electronic board 360 and the components associated therewith and supported thereon. Warm air may pass through the gap and out of the region generally enclosed by the power amplifier casing 350 and then occupy remaining portions of the attic before exiting the attic through the outlet louvers 154. Arrow 374 shows a potential path for air exiting the power amplifier casing 350 and moving toward the outlet louvers 154.

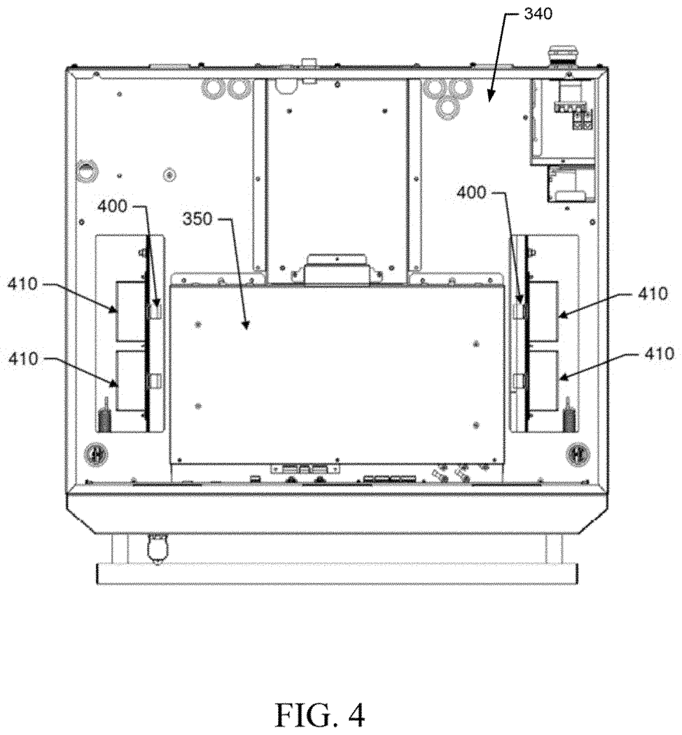

FIG. 4 illustrates a top view of the attic region 340, and shows the power amplifier casing 350 and various components of the antenna assembly 130 including a launcher assembly 400 and waveguides of a waveguide assembly 410. Power is provided from the power amplifier electronics 224 to each launcher of the launcher assembly 400. The launcher assembly 400 operably couples a signal generated by the power amplifiers of the power amplifier electronics 224 into a corresponding one of the waveguides of the waveguide assembly 410 for communication of the corresponding signal into the cooking chamber 102 via the antenna assembly 130 as described above.

The power amplifier electronics 224 are defined by a plurality of electronic circuitry components including opamps, transistors and/or the like that are configured to generate waveforms at the corresponding power levels, frequencies and phases that are desired for a particular situation or cooking program. In some cases, the cooking program may select an algorithm for control of the power amplifier electronics 224 to direct RF emissions into the cooking chamber 102 at selected power levels, frequencies and phases. One or more learning processes may be initiated to select one or more corresponding algorithms to guide the power application. The learning processes may include detection of feedback on the efficacy of the application of power at specific frequencies (and/or phases) into the cooking chamber 102. In order to determine the efficacy, in some cases, the learning processes may measure efficiency and compare the efficiency to one or more thresholds. Efficiency may be calculated as the difference between forward power (P_{fwd}) and reflected power (P_{refl}), divided by the forward power (P_{fwd}). As such, for example, the power inserted into the cooking chamber 102 (i.e., the forward power) may be measured along with the reflected power to determine the amount of power that has been absorbed in the food product (or workload) inserted in the cooking chamber 102. The efficiency may then be calculated as: Efficiency (eff)=(P_{fwd}−P_{refl})/P_{fwd}.

As can be appreciated from the description above, the measurement of the efficiency of the delivery of RF energy to the food product may be useful in determining how effective a particular (e.g., a current) selection for a combination (or pair) of frequency and phase parameters of RF energy applied into the cooking chamber 102 is at delivering heat energy to the food product. Thus, the measurement of efficiency may be useful for selecting the best combination or algorithm for application of energy. The measurement of efficiency should therefore also desirably be as accurate as possible in order to ensure that meaningful control is affected by monitoring efficiency.

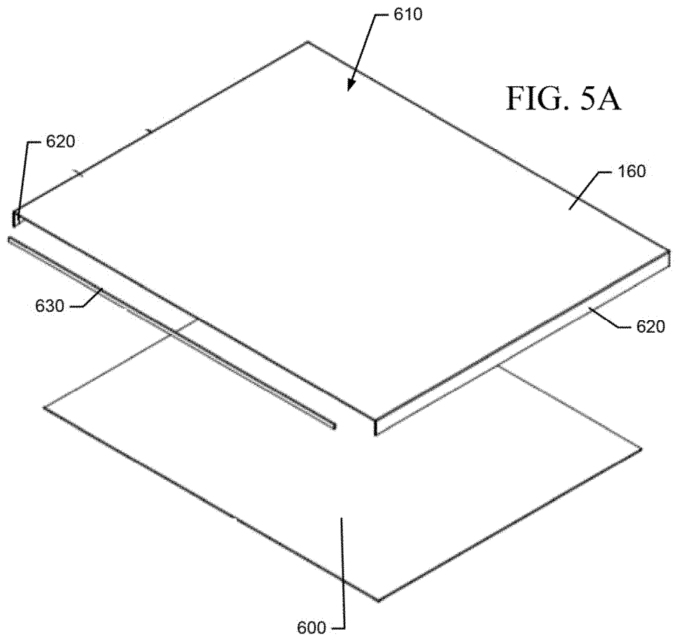

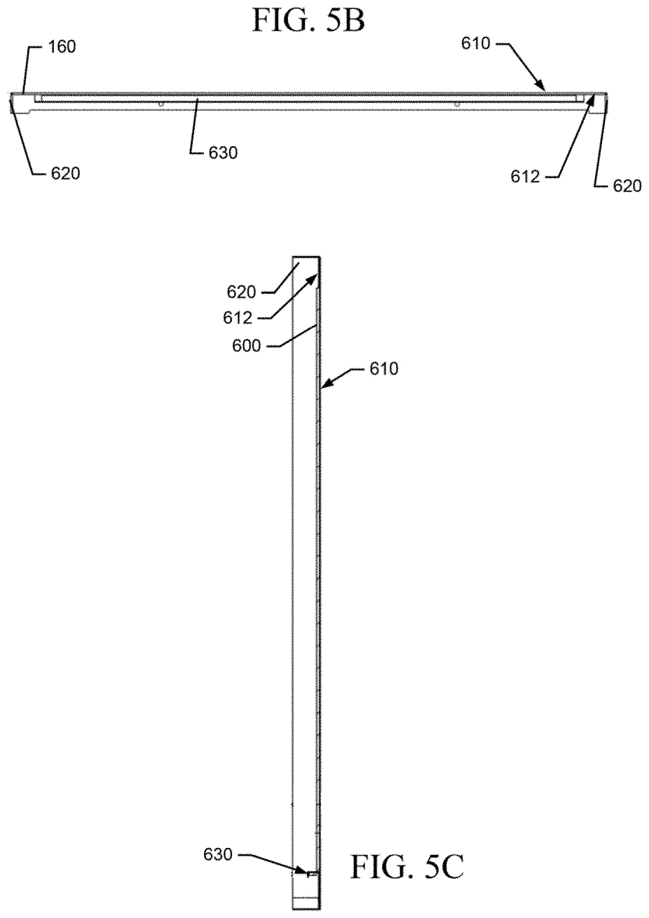

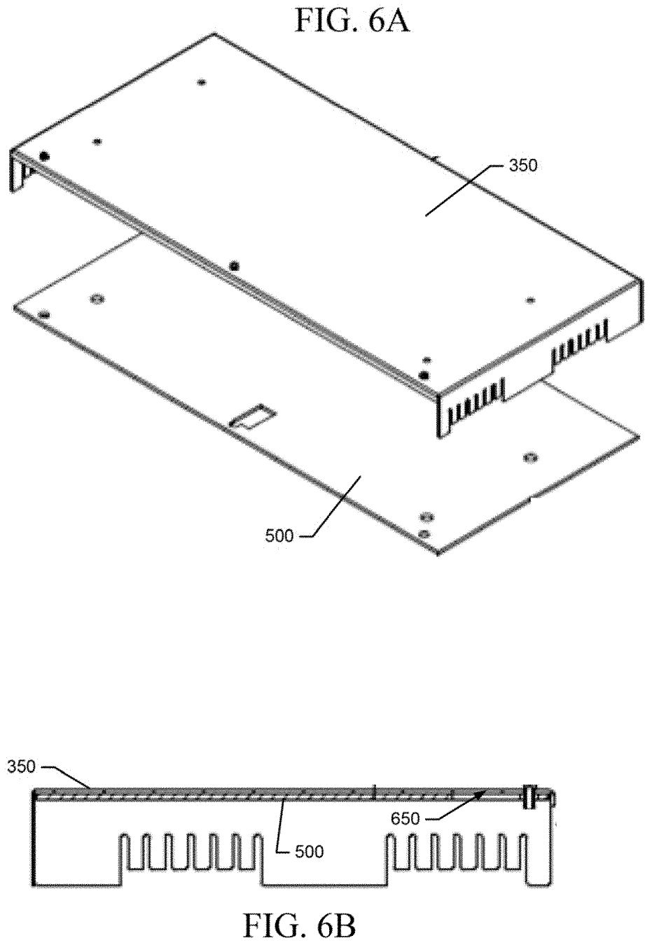

As can be appreciated from FIG. 3A and FIG. 4, due to the volume expansion associated with the air being pushed through the power amplifier casing 350 and into the remaining parts of the attic 340 may cause a slight pressure drop and temperature drop. Thus, air on the top side of the power amplifier casing 350 may be cooler than air on the bottom side of the power amplifier casing 350. To the extent the warm air in the power amplifier casing 350 encounters the bottom surface of the power amplifier casing 350 and the warm air is slightly cooled by the power amplifier casing 350, condensation may also occur on the bottom side of the power amplifier casing 350. To the extent this condensation were to drip onto the power amplifier electronics 224 or other components on the electronic board 360, damage may occur to vital components and the reliability of the oven 100 may be compromised. However, it should be appreciated that, at least with respect to condensation that may form on the underside of the housing cover 160, the power amplifier casing 350 may catch and prevent any such condensation from reaching the power amplifier electronics 224. That said, it would be preferable to avoid such condensation in the first place, both at the bottom surface of the power amplifier casing 350 and the bottom surface of the housing cover 160. Accordingly, example embodiments may provide insulating materials on the bottom surfaces of either or both of the power amplifier casing 350 and the bottom surface of the housing cover 160. The provision of such insulating materials on the bottom surfaces of these components may prevent the cooler temperatures on the top sides of the components from causing warm air at the bottom surfaces from being cooled and thereby causing condensation from forming above vital electronics. Examples of structures that may be employed for these purposes will be discussed in reference to FIGS. 5 and 6.

FIG. 5, which is defined by FIGS. 5A, 5B and 5C, illustrates structures associated with insulating the housing cover 160. In this regard, FIG. 5A is an exploded, perspective view of the housing cover 160 and a housing cover insulator 600. FIG. 5B illustrates a side view of the housing cover 160 from the front perspective (i.e., looking into the oven 100) with the housing cover 160 and housing cover insulator 600 fully assembled. FIG. 5C illustrates a cross section view taken through a centerline of the oven 100 extending from front to back of the oven 100.

Referring to FIGS. 5A, 5B and 5C, it can be appreciated that the housing cover 160 may be a relatively thin piece of sheet metal having a rectangular shape. The housing cover 160 may include a top surface 610 that is generally exposed to ambient temperatures. The housing cover 160 may also include a bottom surface 612 that is exposed to internal temperatures inside the attic 340. In some cases, the top surface 610 and bottom surface 612 may each lie in parallel planes and one or more edge walls 620 of the housing cover 160 may be bent or otherwise extend at a 90 degree angle away from these planes. The edge walls 620 may extend over sidewalls of the oven body 150 to improve the structural integrity of the oven body 150.

In an example embodiment, at least a portion of the bottom surface 612 of the housing cover 160 may have the housing cover insulator 600 provided proximate thereto. For example, the housing cover insulator 600 may be affixed to bottom surface 612 of the housing cover 160. In some cases, an adhesive may be used to affix the housing insulator cover 600 to the bottom surface 612 of the housing cover 160. However, other methods of fixing including the use of fasteners (e.g., screws, rivets, etc.) may alternatively or additionally be employed in some cases.

The housing cover insulator 600 may be a sheet (e.g., rigid or flexible) or membrane of insulating material. In an example embodiment, the housing cover insulator 600 may be cut or otherwise provided to match the size and shape of the bottom surface 612. However, in other cases, the housing cover insulator 600 may be formed to be smaller in size than the dimensions of the bottom surface 612. In some cases, the size (e.g., length and width) of the housing cover insulator 600 may be selected to be about 90% (e.g., +/−5%) of the length and width of the bottom surface 612. In such an example, the housing cover insulator 600 may be positioned on the bottom surface 612 to be spaced apart from at least three (and in some cases all) edges of the bottom surface 612. As such, to the extent any condensation formed, the condensation would only be formed near outer edges of the bottom surface 612 and therefore not above any vital electrical components.

In an example embodiment, a front guard 630 may extend proximate to a forward edge of the housing cover insulator 600, and the front guard 630 may be disposed at a position at which it can be assured that housing cover insulator 600 is disposed over the top of any electronics therebelow, and particularly above the power amplifier casing 350 and the power amplifier electronics 224 therebelow. The front guard 630 may be positioned near or at a front edge of the bottom surface since (as seen in FIG. 4) the power amplifier casing 350 is positioned close to the front portion of the oven 100 within the attic 340. Accordingly, areas of the bottom surface 612 that may not be covered with insulating material of the housing cover insulator 600 may be those portions of the bottom surface 612 that are proximate to outlet louvers 154. In an example embodiment, the front guard 630 may be spaced apart from a front edge of the housing cover 160 by a distance less than or equal to a distance between a front edge of the power amplifier casing 350 and front side of the attic 340.

The housing cover insulator 600 could be made from any of a number of different substances or insulating materials. In an example embodiment, the housing cover insulator 600 may be made from a synthetic rubber material such as ethylene propylene diene terpolymer (EPDM) or other similar materials. The housing cover insulator 600 may have a thickness of about 3 mm. However, other thicknesses could be chosen in some alternative embodiments. When EPDM is used, the EPDM may be cut to size, and then aligned along the front guard 640 and secured to the bottom surface 612 with adhesive, as mentioned above. The EPDM or other insulating material may prevent any cooling on the upper surface 610 of the housing cover 160 from ambient temperatures, and subsequent cooling of the bottom surface 612, from causing warm air in contact with the bottom surface 612 from being cooled and thereby loosing heat carrying capacity to cause condensation. Instead, the insulating material of the housing cover insulator 600 may prevent condensation formation (or selectively relocate any condensation formation to other parts of the oven body 150) to prevent possible exposure of electronic components to drips of condensate from the bottom surface 612.

The condensation inhibiting properties described above in connection with the housing cover insulator 600 notwithstanding, additional measures may be taken in particular to protect the vital electronics of the power amplifier electronics 224 and the electronic board 360. Accordingly, for example, some embodiments may alternatively or additionally employ an insulating member for an internal electronics cover (e.g., the power amplifier casing 350). The insulting member in this example may therefore be referred to as a power amplifier casing (PAC) insulator 500 since the insulating member is configured to insulate an underside of the power amplifier casing 350, which is one example of the internal electronics cover. The PAC insulator 500 may be made of similar (or the same) material to that of the housing cover insulator 600 and may have similar thickness (e.g., about 3 mm). Thus, for example, the PAC insulator 500 may be a sheet (rigid or flexible) or membrane of material such as, for example, EPDM. The PAC insulator 500 may be applied to a bottom surface 650 of the power amplifier casing 350. The application may be conducted with any combination of adhesives, fasteners, retainers or the like. To the extent that fasteners are used, the PAC insulator 500 may include one or more through holes configured to receive a corresponding one of the fasteners.

FIG. 6, which is defined by FIGS. 6A and 6B, illustrates various views of the PAC insulator 500 in accordance with an example embodiment. FIG. 6A illustrates an exploded, perspective view of the power amplifier casing 350 and the PAC insulator 500, and FIG. 6B illustrates a cross sectional view taken through a transverse centerline of the power amplifier casing 350. Additionally, FIG. 3 illustrates various views of the PAC insulator 500 in situ as well.

Referring primarily to FIGS. 3 and 6, the PAC insulator 500 may be formed or cut to have dimensions of size and shape that substantially match the dimensions of the bottom surface 650 of the power amplifier casing 350. However, as with the example housing cover insulator 600 discussed above, the PAC insulator 500 may be sized smaller than the bottom surface 650 in some alternative embodiments. Air that passes above the electronic board 360, in the gap formed by the spacer rods 372 may therefore be insulated from encountering any cool bottom surface 650 and forming condensation thereon. As such, the air may be moved out of the power amplifier casing 350 without any condensation forming therein. The power amplifier electronics 224 may therefore be protected from damage due to contact with water. However, the EPDM or other material selected for the PAC insulator 500 may also provide an electrical screening effect relative to any RF generated internal to the attic 340 as well as mechanical protection for the parts covered by the power amplifier casing 350. As such, the material may also be selected to have good mechanical resistance.

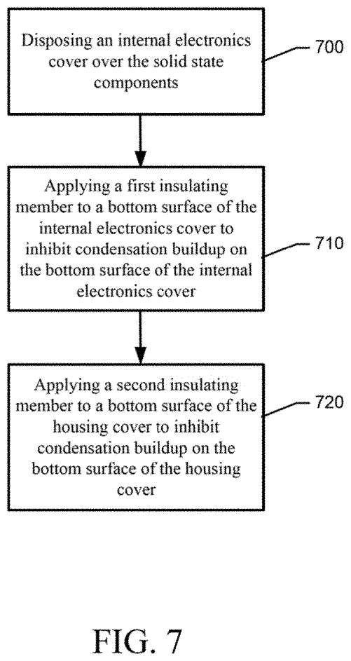

FIG. 7 illustrates a block diagram of a method of inhibiting condensation formation in an oven body of an oven having solid state electronic components used to control RF heating in a cooking chamber of the oven. An internal air cooling system may be configured to move air through the oven body to cool the solid state electronic components. The method may include disposing an internal electronics cover over the solid state components at operation 700. The method may further include applying a first insulating member to a bottom surface of the internal electronics cover to inhibit condensation buildup on the bottom surface of the internal electronics cover at operation 710, and applying a second insulating member to a bottom surface of the housing cover to inhibit condensation buildup on the bottom surface of the housing cover at operation 720.

The method may be modified or augmented with additional steps or by altering details of the steps set forth above. The modifications or augmentations may be accomplished in any combination. In some examples, applying the first insulating member and applying the second insulating member each comprise applying a membrane of EPDM (e.g., via an adhesive). The membrane may be applied having a thickness of about 3 mm. In an example embodiment, applying the first insulating member may include applying the first insulating member to cover substantially all of the bottom surface of the internal electronics cover. In some cases, applying the second insulating member may include applying the second insulating member such that edges of the second insulating member are spaced apart from edges of the housing cover. In an example embodiment, applying the first insulating member may include applying the first insulating member coextensive with an electronics board on which the power amplifier electronics are mounted. In some cases, applying the second insulating member comprises applying the second insulating member in a plane parallel to a plane in which the first insulating member is located and above an entirety of the internal electronics cover.

In an example embodiment, an oven may be provided. The oven may include an oven body having at least sides and a housing cover, a cooking chamber disposed within the oven body and being configured to receive a food product, an RF heating system configured to provide RF energy into the cooking chamber using solid state electronic components to heat the food product, and an internal air cooling system configured to move air through the oven body to cool the solid state electronic components. The solid state electronic components may include power amplifier electronics and control electronics configured to control operation of the power amplifier electronics. The power amplifier electronics may be at least partially covered by an internal electronics cover. A first insulating member may be applied to a bottom surface of at least one of the housing cover or the internal electronics cover to inhibit condensation above the solid state electronic components.

In some embodiments, additional optional features may be included or the features described above may be modified or augmented. Each of the additional features, modification or augmentations may be practiced in combination with the features above and/or in combination with each other. Thus, some, all or none of the additional features, modification or augmentations may be utilized in some embodiments. For example, in some cases, the insulating member may include a membrane of EPDM. In an example embodiment, the membrane may be affixed to the bottom surface of the housing cover or the internal electronics cover by an adhesive. In some cases, the insulating member may have a thickness of about 3 mm. In an example embodiment, a second insulating member may be applied to the bottom surface of the other of the internal electronics cover or the housing cover. In some cases, the first insulating member may be applied to the bottom surface of the housing cover to extend over an entirety of the internal electronics cover to provide parallel thermal barriers above the solid state electronic components. In an example embodiment, the first insulating member may include a housing cover insulator spaced apart from edges of the housing cover. In some cases, the second insulating member may include a power amplifier casing insulator that extends to meet edges of the internal electronics cover. In an example embodiment, the second insulating member may be coextensive with an electronics board on which the power amplifier electronics are mounted. In some cases, the oven body may include an attic region above the cooking chamber. The attic region may include the power amplifier electronics, and the first insulating member may be provided in parallel with a second insulating member in the attic region above the solid state electronic components. In an example embodiment, a front guard may be disposed on the bottom surface of the housing cover. The front guard may extend proximate to a forward edge of the first insulating member. In some cases, the front guard may be spaced apart from a front edge of the housing cover by a distance less than or equal to a distance between a front edge of the internal electronics cover and a front sidewall of the oven body. Example embodiments may therefore provide condensation prevention, but may also add a further safety margin in case of a cold start (or very cold start) of the oven 100, even if operations are attempted to be conducted outside of normal operating conditions. Moreover, the benefits described above may be provided with material that has relatively low weight, low cost, and good thermal and electrical insulation properties.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. An oven comprising:
an oven body comprising at least sides and a housing cover;
a cooking chamber disposed within the oven body, the cooking chamber being configured to receive a food product;
a radio frequency (RF) heating system configured to provide RF energy into the cooking chamber using solid state electronic components to heat the food product; and
an internal air cooling system configured to move air through the oven body to cool the solid state electronic components,
wherein the solid state electronic components include power amplifier electronics and control electronics configured to control operation of the power amplifier electronics,
wherein the power amplifier electronics are at least partially covered by an internal electronics cover, and
wherein a first insulating member is applied to a bottom surface of at least one of the housing cover or the internal electronics cover to inhibit condensation above the solid state electronic components.

2. The oven of claim 1, wherein the insulating member comprises a membrane of ethylene propylene diene terpolymer (EPDM).

3. The oven of claim 2, wherein the membrane is affixed to the bottom surface of the housing cover or the internal electronics cover by an adhesive.

4. The oven of claim 2, wherein the insulating member has a thickness of about 3 mm.

5. The oven of claim 1, wherein a second insulating member is applied to the bottom surface of the other of the internal electronics cover or the housing cover.

6. The oven of claim 5, wherein the first insulating member applied to the bottom surface of the housing cover extends over an entirety of the internal electronics cover to provide parallel thermal barriers above the solid state electronic components.

7. The oven of claim 5, wherein the first insulating member comprises a housing cover insulator spaced apart from edges of the housing cover.

8. The oven of claim 7, wherein the second insulating member comprises a power amplifier casing insulator that extends to meet edges of the internal electronics cover.

9. The oven of claim 5, wherein the second insulating member is coextensive with an electronics board on which the power amplifier electronics are mounted.

10. The oven of claim 1, wherein the oven body comprises an attic region above the cooking chamber,
wherein the attic region includes the power amplifier electronics, and
wherein the first insulating member is provided in parallel with a second insulating member in the attic region above the solid state electronic components.

11. The oven of claim 1, wherein a front guard is disposed on the bottom surface of the housing cover,
wherein the front guard extends proximate to a forward edge of the first insulating member.

12. The oven of claim 11, wherein the front guard is spaced apart from a front edge of the housing cover by a distance less than or equal to a distance between a front edge of the internal electronics cover and a front sidewall of the oven body.

13. A method of inhibiting condensation formation in an oven body of an oven having solid state electronic components used to control radio frequency (RF) heating in a cooking chamber of the oven, and an internal air cooling system configured to move air through the oven body to cool the solid state electronic components, the method comprising:
disposing an internal electronics cover over the solid state components;
applying a first insulating member to a bottom surface of the internal electronics cover to inhibit condensation buildup on the bottom surface of the internal electronics cover; and
applying a second insulating member to a bottom surface of the housing cover to inhibit condensation buildup on the bottom surface of the housing cover.

14. The method of claim 13, wherein applying the first insulating member and applying the second insulating member each comprise applying a membrane of ethylene propylene diene terpolymer (EPDM).

15. The method of claim 14, wherein applying the membrane comprises affixing the EPDM to the bottom surface of the housing cover and the internal electronics cover, respectively, using an adhesive.

16. The method of claim 14, wherein applying the membrane comprises applying the membrane having a thickness of about 3 mm.

17. The method of claim 13, wherein applying the first insulating member comprises applying the first insulating member to cover substantially all of the bottom surface of the internal electronics cover.

18. The method of claim 13, wherein applying the second insulating member comprises applying the second insulating member such that edges of the second insulating member are spaced apart from edges of the housing cover.

19. The method of claim 13, wherein applying the first insulating member comprises applying the first insulating member coextensive with an electronics board on which the power amplifier electronics are mounted.

20. The method of claim 13, wherein applying the second insulating member comprises applying the second insulating member in a plane parallel to a plane in which the first insulating member is located and above an entirety of the internal electronics cover.
